(19) United States
(12) Patent Application Publication
(10) Pub. No.: US 2003/0135566 A1
(43) Pub. Date: Jul. 17, 2003

(54) File transmission apparatus, web server, file transmission system, file transmission program storage medium, and web server program storage medium

(75) Inventors: Naoki Nishiguchi, Kawasaki (JP); Akihiro Sasakura, Kawasaki (JP); Kouta Yoshida, Kawasaki (JP); Masao Gunji, Kawasaki (JP); Yoshihiko Murakawa, Kawasaki (JP); Isao Aoki, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/128,270

(22) Filed: Apr. 24, 2002

(30) Foreign Application Priority Data
Jan. 11, 2002 (JP) 2002-4244

(51) Int. Cl. G06F 15/16

(52) U.S. Cl. 709/206; 709/203

(57) ABSTRACT

A home gateway which receives an e-mail and transmits a file as instructed by the e-mail, comprises: a mail receiver receiving an e-mail; a mail analyzer analyzing the e-mail received by the mail receiver and specifying a requested file for transmission; a file transmitter transmitting, to a web server on the Internet, the file specified by the mail analyzer; and a mail notification unit transmitting, to a terminal, an e-mail indicating that the file transmitter has transmitted the requested file to the web server.

### BACKGROUND OF THE INVENTION

1. Field of the Invention

The present invention relates to a file transmission apparatus for receiving an e-mail and for transmitting a file as instructed by the e-mail, a web server on the Internet for storing a file that is received and for, upon receiving a file transmission request, transmitting the file to a requesting source, a file transmission system which includes the file transmission apparatus and the web server, and a file transmission program storage medium and a web server program storage medium on which are respectively stored a file transmission program permitting a computer to serve as the file transmission apparatus and a web server program permitting a computer to serve as the web server of the present invention.

2. Description of the Related Art

Recently, a so-called home gateway was proposed that is intended to provide facilities for the home-based storage of various data, such as assorted monitor images and incoming e-mail and monitoring information acquired by a home security sensor, that a householder, employing a portable terminal, can access from outside the home to confirm monitor images on file or to transfer e-mail that has been received. In order to access a home gateway using a portable terminal, the home gateway must be connected directly to the Internet using a global address. However, with the increase in popularity of the Internet, the available global addresses have been exhausted, so that private addresses may be used for connecting to the Internet.

In a case wherein a connection to the Internet is effected via a cable television line, the host computer of the pertinent cable television company is the one directly connected to the Internet. In some cases, addresses (private addresses) that are not globally unique are provided for home gateways at individual homes, although for the reception of cable television the home gateways are individually identified as subscribers.

Note that in an environment wherein a home gateway is connected indirectly to the Internet using a private address, it is impossible for the home gateway to be accessed directly from the Internet.

Thus, a method for which e-mail is used has been discussed.

Specifically, first, a portable terminal transmits an e-mail to a home gateway. This e-mail is temporarily stored in a mail server on the Internet. Then, since the home gateway can access the Internet, in response to an access initiated by the home gateway the e-mail is transmitted by the mail server to the home gateway. Thereafter, the home gateway analyzes the received e-mail, and when a file transmission request is included therein, the home gateway transmits the requested file, together with the e-mail, to the portable terminal. As is described above, according to the method for which e-mail is employed, a desired file can be obtained from a home gateway that employs a private address.

However, there are some portable terminals that can receive only the character data in an e-mail and can not receive an attached image. This type of portable terminal can not provide the same effect as that of the one directly accesses a home gateway that has a global address and is directly connected to the Internet, and a great deficiency in that images can not be received still remains.

### SUMMARY OF THE INVENTION

To resolve the problem, it is one objective of the present invention to provide a file transmission apparatus, such as a home gateway, that can transmit a file, including an image file, even when a private address is employed; a web server that controls the transmission of a file to a terminal; a file transmission system that includes the file transmission apparatus and the web server; a file transmission program storage medium on which is stored a file transmission program that permits a computer to serve as the file transmission apparatus of the present invention; and a web server program storage medium on which is stored a web server program that permits a computer to serve as the web server of the present invention.

To achieve this objective, according to the present invention, a file transmission apparatus, which receives an e-mail and transmits a file as instructed by the e-mail, comprises:

a mail receiver receiving an e-mail;

a mail analyzer analyzing the e-mail received by the mail receiver and specifying a requested file for transmission; and

a file transmitter transmitting, to a web server on the Internet, the file specified by the mail analyzer.

According to the present invention, the file transmission apparatus receives an e-mail from a terminal or the like through a mail server, and instead of transmitting to the mail source terminal, transmits a requested file to a web server on the Internet for example, where the file transmission apparatus opens the homepage, to update the homepage. In this manner, the terminal or the like that issued the e-mail accesses the web server on the Internet, and can receive a desired file requested by the e-mail. In this case, even an image file can be received by the terminal or the like.

It is preferable that the file transmission apparatus of the present invention further comprise:

a mail notification unit for transmitting, to an e-mail transmission source, an e-mail indicating that the file transmitter has transmitted to the web server a file requested by the e-mail received by the mail receiver.

As a result, the terminal or the like at the e-mail transmission source can easily ascertain that the file the e-mail instructed the terminal to transmit has been transmitted to the web server.

With the above described arrangement including the file notification unit, it is also preferable that the mail notification unit transmit to the e-mail transmission source an e-mail that includes a URL (Uniform Resource Locator: a description used to designate a server employed for the Internet and a linking destination for a file in the server) used to access a file transmitted by the file transmitter to the web server.

In this case, the terminal or the like at the e-mail transmission source can ascertain that a desired file has been transmitted to the web server, and can easily access the web server.

Further, according to the present invention, it is preferable that the file transmission apparatus also comprise:

a server selector selecting one of multiple web servers to which the file specified by the mail analyzer is to be transmitted,

wherein the file transmitter transmits the file specified by the mail analyzer to the web server that is selected by the server selector.

The server selector can employ any information to select the web server; for example, the address of the e-mail transmission source that requests the transmission of the file can be employed to select the web server. Therefore, an appropriate web server can be selected in accordance, for example, with the terminal or the like that requested the file transmission.

According to the present invention, in the file transmission apparatus for transmitting, to an e-mail transmission source requesting the transmission of a file, an e-mail that includes a URL for accessing a file transmitted to a web server, it is preferable that, in order for a file specified by the mail analyzer to be transmitted to the web server, the file transmitter generate at a transmission destination a directory and/or a file name that can not be predicted, and transmit a file to a URL whereat the directory and/or the file name has been generated.

As a result, it is difficult to guess which URL will finally be accessed, and it is possible to prevent the file from being read by a third party.

According to the present inventions it is preferable that the file transmission apparatus further comprise:

a transmitted file recording unit recording information for specifying a file that has been transmitted by the file transmitter,

wherein the file transmitter refers to information recorded in the transmitted file recording unit to avoid the re-transmission of a file that has already been transmitted.

Then, the re-transmission of a file that has been transmitted once can be prevented, and the amount of unnecessary traffic can be reduced.

In the file transmission apparatus of the present invention, it is preferable that the file transmitter confirm the availability of free disk space at the web server, and obtain the free disk space required for a file before the file is transmitted to the web server.

Therefore, the disk capacity of the web server can be appropriately managed at the file transmission destination.

In the file transmission apparatus of the present invention, it is also preferable that the file transmitter transmit to the web server, together with the file specified by the mail analyzer, a file in which a condition for permitting a file access is recorded.

As a result, a limited number of accesses, an effective period of time for accesses and the like can be provided, so that the reading of a file by a third party can be prevented.

Further, according to the present invention, in the file transmission apparatus, it is preferable that the mail analyzer examine the transmission sources of e-mails that are received by the mail receiver, analyze an e-mail transmitted by a verified transmission source and specify a requested file to be transmitted.

Thus, the reception of an unauthorized e-mail can be prevented, and the submission by a third party of an unauthorized file request can be precluded.

Further, to achieve the above objective, according to the present invention, a first web server on the Internet, one which receives and stores a file and transmits the file to a transmission requesting source upon the reception of a transmission request for the file, comprises:

a mail generator, upon receiving an instruction from a terminal that is operated as a file transmission requesting resource, creating an e-mail that instructs the transmission of a file requested by the terminal;

a mail transmitter transmitting the e-mail, created by the mail generator, to a file transmission apparatus whereat the file requested by the terminal is stored and whereat the e-mail is received and the file is transmitted as instructed by the e-mail;

a file receiver receiving the file from the file transmission apparatus that received the e-mail from the mail transmitter;

a file storage unit storing the file received by the file receiver; and

a file transmitter, upon receiving a request from the terminal for the transmission of the file stored in the file storage unit, transmitting the file to the terminal.

According to the first web server of the present invention, since an e-mail instructing the transmission of a file is created and transmitted by the web server, the terminal need only provide, for the web server, information required for the creation of the e-mail, so that the labor associated with input of the e-mail at the terminal can be reduced. Further, even for a terminal that does not support PGP (Pretty Good Privacy: one of the encryption methods proposed in order to maintain communication secrecy on the Internet) or the like, so long as the web server provides such support an unauthorized e-mail can be prevented.

For the first web server of the present invention, it is preferable that the mail generator correctly examine the terminal, receive an instruction from the terminal that has been verified, and create an e-mail instructing the transmission of a file requested by the terminal.

Since the web server performs this verification, only a permitted user can transmit an e-mail, and further, a page can also be processed in accordance with the user.

For the first web server of the present invention, it is preferable that the mail generator create an e-mail including information representing a terminal type.

Since the web server determines the terminal type and adds this information to the e-mail, the file transmission apparatus can perform., for the file to be transmitted, the conversion of the size and color of an image as is appropriate for the terminal. The terminal can browse a file that, for the terminal, has an appropriate form.

According to the present invention, it is preferable that a second web server on the Internet, one which receives and stores a file and transmits the store file to a transmission requesting source upon the reception of a transmission request for the file, comprise:

a file receiver receiving a file;

a file storage unit storing the file received by the file receiver; and

a file transmitter, upon receiving a request for the transmission of the file stored in the file storage unit, transmits the file to a transmission requesting source,

wherein the file transmitter correctly examines the transmission requesting source, and upon receiving a transmission request from the transmission requesting source that has been verified, transmits the file stored in the file storage unit to the transmission requesting source.

Since the verification is performed when the transmission requesting source accesses the web server, an unauthorized access by a third party can be prevented.

According to the present invention, it is preferable that a third web server on the Internet, one which receives and stores a file and upon the reception of a transmission request for the stored file transmits the file to a transmission requesting source, comprise:

a file receiver receiving a file;

a file storage unit storing the file received by the file receiver; and

a file transmitter, upon receiving a transmission request for the file stored in the storage unit, transmitting the file to the transmission request source,

wherein the file receiver receives, from the file transmitter, the file requested by the transmission requesting source, and also receives a file in which is recorded the conditions under which access to the file is permitted, and

wherein the file transmitter transmits the file to the transmission requesting source only when the request received for the transmission of the file stored in the file storage unit matches the conditions under which access to the file is permitted.

Therefore, since the web server manages the limits imposed on the frequency whereat the file can be referred to, the effective period of time and the like, an unauthorized access by a third party can be prevented.

According to the present invention, it is preferable that a fourth web server on the Internet, one which receives and stores a file and upon the reception of a transmission request for the file that is stored transmits the file to a transmission requesting source, comprise:

a file receiver receiving a file;

a file storage unit storing the file received by the file receiver;

a file transmitter, upon receiving a transmission request for the file stored in the file storage unit, transmitting the file to the transmission source;

a file form converter, upon receiving the transmission request for the file stored in the file storage unit, changing the file into a form appropriate for the type of transmission requesting source,

wherein the file transmitter transmits, to the transmission requesting source, the file for which the form has been changed by the file form converter.

Since the type of the transmission requesting source is determined when the web server is accessed, and the form of the requested file is converted into one appropriate for the type of transmission requesting source, the transmission requesting source can browse a file that, for the transmission requesting source, has an appropriate form. Further, since the web server changes the file form, the file transmission apparatus does not need to convert the file form, and the load imposed on the file transmission apparatus can be reduced.

To achieve the above objective of the present invention, a file transmission system comprises:

a file transmission apparatus receiving an e-mail and transmitting a file as instructed by the e-mail;

a web server, on the Internet, storing the file received from the file transmission apparatus and, upon receiving a transmission request for the stored file, transmitting the file to a transmission requesting source; and

a terminal communicating with the file transmission apparatus and the web server,

wherein the terminal issues an e-mail to the file transmission apparatus directly or via the web server to request the transmission of a file,

wherein the file transmission apparatus transmits the requested file to the web server,

wherein the terminal requests the web server to transmit the file that has been received from the file transmission apparatus, and

wherein the web server transmits the file to the terminal upon receiving a request from the terminal for the transmission of the file.

According to the file transmission system of the present invention, a remote access by the terminal of the file transmission apparatus can be performed by using an e-mail and a homepage prepared on the web server, without directly accessing the file transmission apparatus using HTTP (Hyper-Text Transfer Protocol: the Internet homepage is written in a hypertext description language called HTML, and HTTP is employed for communication between a server and a client user). Therefore, even when for a file transmission apparatus, such as a home gateway in which a private address is employed, while absent from home a user can browse information held at the user's home. In addition, according to the file transmission system of the present invention, the file transmission apparatus, such as the home gateway, need not provide a special service, and can also be set to inhibit the acceptance of an access by closing a port, so that security is improved.

According to the file transmission system of the present invention, it is preferable that the file transmission apparatus transmit, to the web server, a file requested using an e-mail, and that the file transmission apparatus also transmit to the terminal an e-mail indicating that the file has been transmitted.

As a result, the terminal can easily ascertain that the requested file that is to be browsed has been transmitted to the web server.

Furthermore, to achieve the above object, the present invention provides a file transmission program storage medium storing a file transmission program that is executed by a computer and that permits the computer to serve as a file transmission apparatus receiving an e-mail and transmitting a file as instructed by the e-mail,

wherein the computer comprises:

a mail receiver receiving an e-mail;

a mail analyzer analyzing the e-mail received by the mail receiver and specifying a file for which transmission has been requested; and

a file transmitter transmitting to a web server on the Internet the file designated by the mail analyzer.

The file transmission program, which is stored on the file transmission program storage medium of the present invention, includes all the functions that correspond to the modes for the file transmission apparatus according to the present invention.

Further, to achieve the objective, the present invention provides a first web server program storage medium storing a web server program that is executed by a computer and that permits the computer to serve as a web server receiving and storing a file and transmitting the stored file to a transmission requesting source upon the reception of a transmission request,

wherein the computer comprises:

a mail generator receiving an instruction from a terminal that serves as a file transmission requesting source, and creating as instructed an e-mail to transmit the file requested by the terminal;

a mail transmitter transmitting the e-mail created by the mail generator to a file transmission apparatus receiving an e-mail and transmitting a file as instructed by the e-mail, whereat the file requested by the terminal is stored;

a file receiver receiving a file from the file transmission apparatus that has received the e-mail from the mail transmitter;

a file storage unit storing the file received by the file receiver; and

a file transmitter, upon receiving a request from the terminal for the transmission of a file stored in the file storage unit, transmitting the file to the terminal.

Furthermore, the present invention provides a second web server program storage medium storing a web server program that is executed by a computer and that permits the computer to serve as a web server receiving and storing a file and transmitting the stored file to a transmission requesting source upon the reception of a transmission request,

wherein the computer comprises:

a file receiver receiving a file;

a file storage unit storing the file received by the file receiver; and

a file transmitter, upon receiving a transmission request for the file stored in the file storage unit, transmitting the file to a transmission requesting source,

wherein the file transmitter examines the transmission requesting source, and upon receiving a transmission request from the transmission requesting source that has been verified, transmits the file stored in the file storage unit to the transmission requesting source.

The present invention further provides a third web server program storage medium storing a web server program that is executed by a computer and that permits the computer to serve as a web server receiving and storing a file and transmitting the stored file to a transmission requesting source upon the reception of a transmission request,

wherein the computer comprises:

a file receiver receiving a file;

a file storage unit storing the file received by the file receiver; and

a file transmitter, upon receiving a transmission request for the file stored in the file storage unit, transmitting the file to a transmission requesting source,

wherein the file receiver receives a file, and also receives a file in which is recorded a condition under which access of the file is permitted, and

wherein the file transmitter transmits the file to the transmission requesting source only when a request received for the transmission of the file stored in the file storage unit matches the condition under which access of the file is permitted.

Further, the present invention provides a fourth web server program storage medium storing a web server program that is executed by a computer and that permits the computer to serve as a web server receiving and storing a file and transmitting the stored file to a transmission requesting source upon the reception of a transmission request,

wherein the computer comprises:

a file receiver receiving a file;

a file storage unit storing the file received by the file receiver;

a file transmitter, upon receiving a transmission request for the file stored in the file storage unit, transmitting the file to a transmission requesting source; and

a file form converter, upon receiving a transmission request for the file stored in the file storage unit, changing the file into a form matching the type of the transmission requesting source,

wherein the file transmitter transmits, to the transmission requesting source, the file for which the form has been changed by the file form converter.

As well as the file transmission program of the present invention, the web server program, which is stored in the web server program storage medium according to the present invention, includes all the functions corresponding to the modes for the web server of the present invention.

### BRIEF DESCRIPTION OF THE DRAWINGS

FIG. 1 is diagram showing the overall configuration of a file transmission system according to one embodiment of the present invention;

FIG. 2 is a diagram showing an example use for the file transmission system in FIG. 1;

FIG. 3 is a diagram showing another example use for the file transmission system in FIG. 1;

FIG. 4 is a diagram showing an additional example use for the file transmission system in FIG. 1;

FIG. 5 is a diagram showing the external appearance of a typical computer;

FIG. 6 is a diagram showing the hardware configuration of a computer having the external appearance shown in FIG. 5;

FIG. 7 is a schematic diagram showing the configuration of a file transmission program stored in the file transmission program storage medium according to one embodiment of the present invention;

FIG. 8 is a functional block diagram showing a file transmission apparatus according to one embodiment of the present invention;

FIG. 9 is a schematic diagram showing the configuration of a web server program stored in the web server program storage medium according to one embodiment of the present invention;

FIG. 10 is a functional block diagram showing a web server according to one embodiment of the present invention;

FIGS. 11A and 11B are diagrams showing e-mails that are transmitted by or received by a terminal in FIG. 1;

FIG. 12 is a diagram showing example web server information defined in the web server information file in FIG. 8;

FIG. 13 is a flowchart showing a first example operation of the home gateway;

FIG. 14 is a flowchart showing a second example operation of the home-gateway;

FIG. 15 is a diagram showing example web server information defined in the web server information file;

FIG. 16 is a flowchart showing a third example operation of the home gateway;

FIG. 17 is a flowchart showing a fourth example operation of the home gateway;

FIG. 18 is a diagram showing the list of transmitted files that are recorded by a transmitted file recording unit in FIG. 8;

FIG. 19 is a flowchart showing a fifth example operation of the home gateway;

FIG. 20 is a diagram showing another example of web server information;

FIG. 21 is a flowchart showing a sixth example operation of the home gateway;

FIG. 22 is a flowchart showing a seventh example operation of the home gateway;

FIG. 23 is a flowchart showing an eighth example operation of the home gateway;

FIG. 24 is a flowchart showing the operation of the terminal;

FIG. 25 is a flowchart showing the operation of the web server at the time mail is transmitted;

FIG. 26 is a flowchart showing the operation of the web server at the time data is accessed; and

FIGS. 27A to 27E are diagrams showing examples in a series of screens displayed on the terminal.

### DETAILED DESCRIPTION OF THE PREFERRED EMBODIMENT

The preferred embodiment of the present invention will now be described while referring to the accompanying drawings.

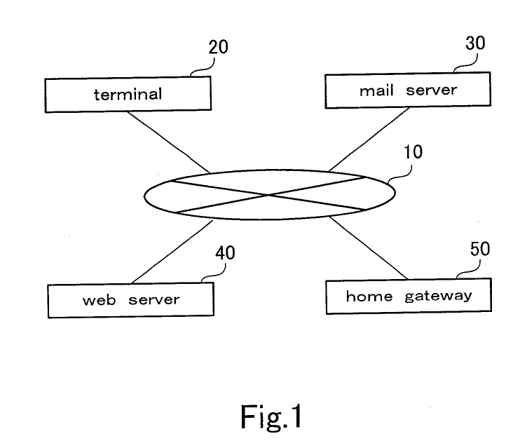

FIG. 1 is a diagram showing the overall configuration of a file transmission system according to one embodiment of the present invention.

In FIG. 1, a terminal 20, a mail server 30, a web server 40 and a home gateway 50 are connected via the Internet 10. The terminal 20, the mail server 30 and the web server 40, for which global addresses are supplied, are directly connected to the Internet 10. The home gateway 50 is connected to the Internet 10 via a home gateway host machine (not shown), and a private address unique only under the control of the home gateway host machine is provided for the home gateway 50.

The home gateway 50 is a machine for fetching and holding various data at a home. A specific example will be described later. Further, the home gateway 50 can transmit and receive e-mail via the mail server 30, and can transmit a file to the Internet. It does not matter whether this home gateway has the external appearance of a personal computer, but in this embodiment, the home gateway has a function as a computer that internally executes various programs.

The web server 40 is a server on the Internet that carries the homepage of the home gateway 50. The web server 40 receives a file from the home gateway 50, and discloses the file to the terminal 20.

The mail server 30 is a server for collecting and delivering e-mails that are exchanged via the Internet 10, and for receiving and storing an e-mail in an e-mail box. Further, the mail server 30 functions as a POP (Post Office Protocol) or IMAP (Internet Message Access Protocol) server, and transmits an e-mail received from the terminal 20 to the home gateway 50 or one received from the home gateway 50 to the terminal 20. The number of mail servers is not always one, and may be respectively positioned for a terminal and a home gateway. Further, a mail server is not necessarily separated from a terminal and a home gateway, and may serve as a part of a terminal and a home gateway.

The terminal 20 is a portable device, such as a portable telephone, and is used for remotely accessing the home gateway 50. However, the terminal 20 is not necessarily a portable device, and may be a fixed-type terminal.

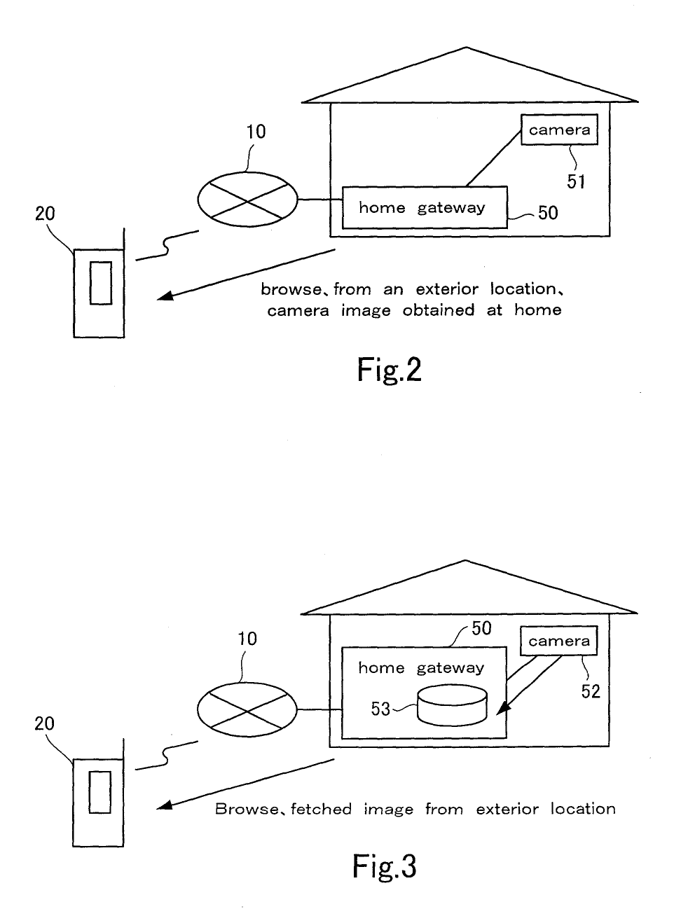

FIGS. 2 to 4 are diagrams showing various use examples of the file transmission system in FIG. 1.

In FIG. 2, a video camera 51 for monitoring the inside of a house is connected to the home gateway 50, and a video image obtained by the camera in the home can be browsed using the externally located terminal 20.

In FIG. 3, an image obtained by a digital still camera 52 is fetched in advance in a storage unit 53 of the home gateway 50, and is browsed in an external location.

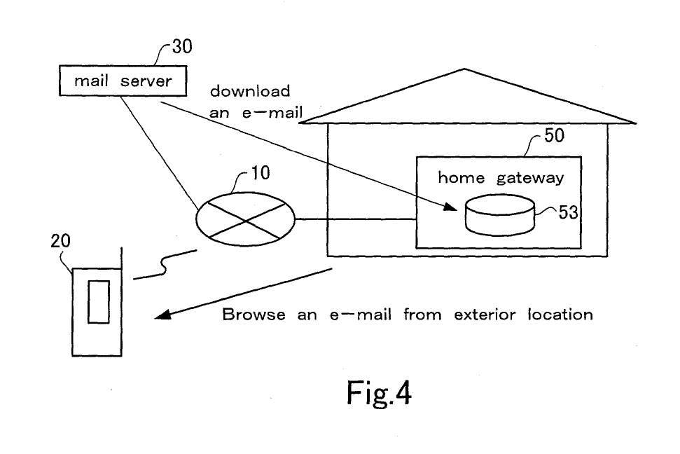

In FIG. 4, the home gateway 50 periodically accesses the mail server 30, and fetches, in the storage unit 53, e-mail addressed to the home gateway 50. The terminal 20 is manipulated by a user at an external location to browse the e-mail.

As is shown in FIGS. 2 to 4, various home data are fetched by the home gateway 50, and in this embodiment, by manipulating the terminal 20 a required file, including an image file, can be fetched and transmitted to the terminal 20, even when the home gateway 50 has a private address.

An explanation will now be given for the processing performed by the file transmission system in FIG. 1 when fetching a desired file in the terminal 20.

First, the terminal 20 transmits an e-mail to the home gateway 50, directly or via the web server 40, requesting the transmission of a file, and thereafter, the home gateway 50 transmits the requested file to the web server 40. The terminal 20 then requests the web server 40 to transmit the file that it received from the home gateway 50. Following this, upon the reception of the file transmission request from the terminal 20, the web server 40 transmits the file to the terminal 20.

Further, the home gateway 50 transmits, to the web server 40, the file requested by means of the e-mail, and transmits the e-mail to notify the terminal 20 that the file has been transmitted.

Through this processing, the terminal 20, which has received the e-mail, can access the web server 40, and receive a desired file, including an image file.

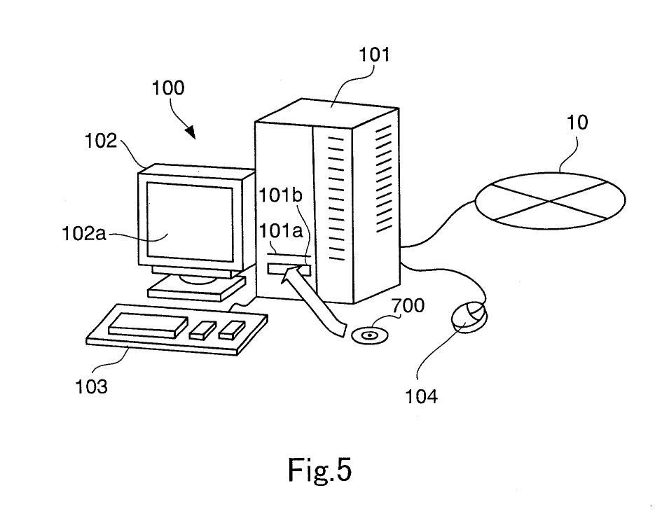

FIG. 5 is a diagram showing the external appearance of a typical computer.

As is described above, a home gateway does not need to have the appearance of a computer. However, in this embodiment, a common personal computer is employed as a home gateway 50, and a computer that can serve as a home gateway 50 will be explained. In this embodiment, basically, the web server 40 and the mail server 30 are also implemented as common personal computers, and the explanation given for the computer available as the home gateway 50 also applies to the hardware configurations of the web server 40 and the mail server 30. It should be noted that no explanation will be given for the hardware configuration of the terminal 20.

As is shown in FIG. 5, a computer 100 comprises: a main body unit 101 incorporating a CPU (Central Processing Unit), a RAM (Random Access Memory), a hard disk, a communication board and the like; a display unit 102 for, upon receiving an instruction from the main body unit 101, displaying an image and a character string on a display screen 102a; a keyboard 103 for a user to enter an instruction in the computer 100; and a mouse 104 used to designate an arbitrary location on the display screen 102a whereat, in accordance with an icon displayed at the designated position, an instruction can be entered.

The main body unit 101 includes, as a portion of its exterior appearance, a flexible disk slot 101a and a CD-ROM slot 101b, through which, respectively, a flexible disk (not shown) and a CD-ROM 700 are loaded, and internally incorporates a flexible drive and a CD-ROM drive that respectively drive and access a flexible disk and a CD-ROM 700 that are loaded using the slots 101a and 10b.

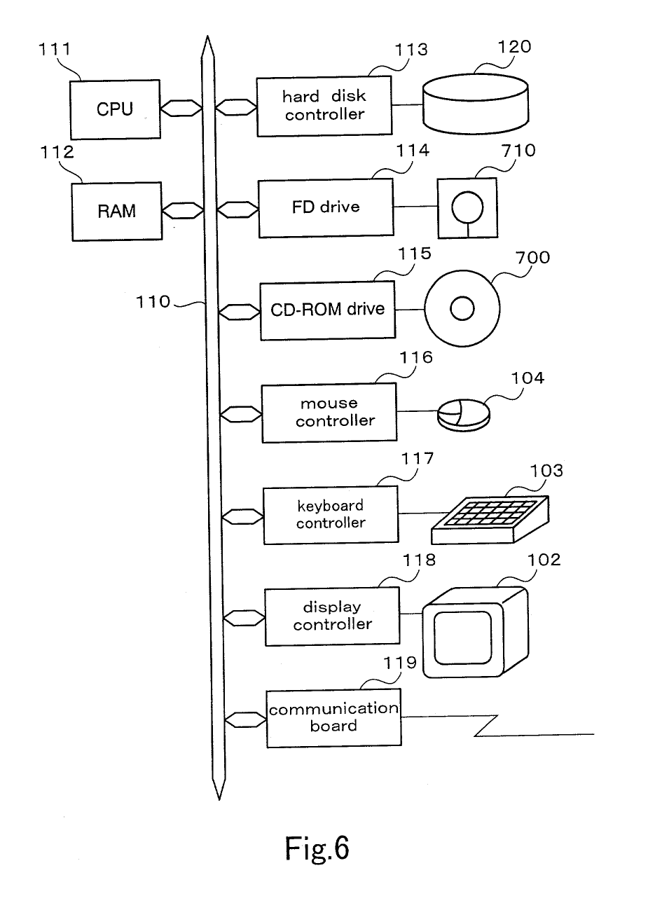

FIG. 6 is a diagram showing the hardware configuration of a computer having the external appearance in FIG. 5.

In FIG. 6, the hardware configuration includes a CPU 111, a RAM 112, a hard disk controller 113, a flexible disk drive 114, a CD-ROM drive 115, a mouse controller 116, a keyboard controller 117, a display controller 118 and a communication board 119, all of which are interconnected by a bus 110.

As explained while referring to FIG. 5, the flexible disk drive 114 and the CD-ROM drive 115 access a flexible disk 710 and a CD-ROM 700 that are respectively loaded through the flexible disk slot 101a and the CD-ROM slot 101b. The communication board 119 is used to communicate with external entities.

Further, the configuration in FIG. 6 includes a hard disk 120, accessed by the hard disk controller 113, a mouse 104 controlled by the mouse controller 116, a keyboard 103 controlled by the keyboard controller 117, and a CRT display 102 controlled by the display controller 118.

With this arrangement, the CD-ROM 700, which is a file transmission program storage medium on which is stored a file transmission program that will be described later, is inserted into the CD-ROM slot 101b of the computer 100, and the file transmission program stored on the CD-ROM 700 is installed in the computer 100.

Alternately, the file transmission program may be downloaded to the computer 100 via the Internet 10.

The file transmission program may also be stored in advance in a storage medium (e.g., a hard disk) incorporated in the computer 100.

The file transmission program will be described later.

In addition to the file transmission program, various other programs required for the operation as the home gateway 50 of the computer 100 in FIGS. 5 and 6 are also installed in the computer 100. Since the conventional programs can be employed directly for the computer 100 and are not related to the subject of the present invention, no explanation will be given for these programs in this embodiment, and it is assumed that such programs are already installed in the computer 100.

In the above explanation, the computer 100 in FIGS. 5 and 6 is used as a home gateway, and the file transmission program is installed in the computer 100. However, a web server program and other programs required for the operation of the computer as a web server may be installed in the same type of computer as the computer 100 shown in FIGS. 5 and 6, so that a pertinent computer can be employed as a web server. The web server program used for this embodiment will be described later. Further, as programs other than the web server program that operates the computer as a web server in this embodiment, only conventional programs need to be installed and used, thus no further explanation for them will be given.

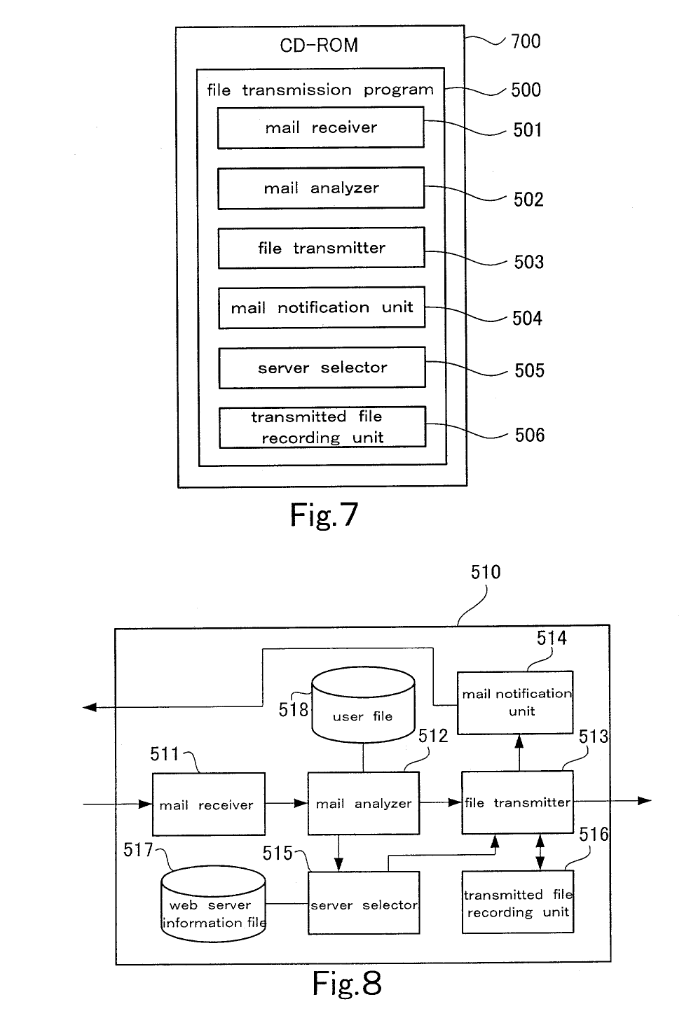

FIG. 7 is a schematic diagram showing the structure of a file transmission program that is stored in a file transmission program storage medium in accordance with the embodiment of the present invention.

A file transmission program 500 in FIG. 7 is stored in the CD-ROM 700 shown in FIGS. 5 and 6. Included in the file transmission program 500 is a mail receiver 501, a mail analyzer 502, a file transmitter 503, a mail notification unit 504, a server selector 505 and a transmitted file recording unit 506. The operations of these components 501 to 506 will be described together with the individual sections of a file transmission apparatus 510 in FIG. 8.

FIG. 8 is a functional block diagram showing the file transmission apparatus 510 according to the embodiment of the present invention.

The file transmission apparatus 510 in FIG. 8 is constructed in the computer by installing and executing the file transmission program 500 in FIG. 7 in the computer 100 in FIGS. 5 and 6, and corresponds to the file transmission function of the home gateway 50 in FIG. 1.

The file transmission apparatus 510 in FIG. 8, which receives an e-mail and transmits a file as instructed by the received e-mail, comprises: a mail receiver 511, a mail analyzer 512, a file transmitter 513, a mail notification unit 514, a server selector 515 and a transmitted file recording unit 516. The file transmission apparatus 510 further includes a web server information file 517 in which a user defines multiple web servers, and a user file 518 in which various files (files such as images and e-mails stored in the home gateway 50 in FIGS. 2 to 4) are stored for the user. Since the user file 518 is constructed in the same manner as is a conventional home gateway, no further explanation for it will be given.

The mail receiver 511 of the file transmission apparatus 510 in FIG. 8 periodically accesses the mail server 30 in FIG. 1, and fetches, from the mail server 30, e-mail addressed to the file transmission apparatus 510. In this embodiment, the mail receiver 511 employs a POP (Post Office Protocol; one of the protocols concerning e-mail transfer) server to receive e-mail from the mail server 30. When the home gateway is directly operated by the Internet 10, the home gateway may serve as the mail server.

Assume that an e-mail requesting the transmission of a file is received from the terminal 20 in FIG. 1.

Upon receiving the e-mail, the mail receiver 511 examines the transmission source of the e-mail, and thereafter, it transmits the e-mail to the mail analyzer 512 only if the transmission source is verified.

The mail receiver 511 of the file transmission apparatus 510 in FIG. 8 is constructed using both the hardware of the computer 100 in FIGS. 5 and 6 and the software executed thereby, while the mail receiver 501 of the file transmission program 500 in FIG. 7 is constructed by employing, of all the software used for the computer, only the application program. The individual sections 511 to 516 of the file transmission apparatus 510 in FIG. 8 correspond to the sections 501 to 506 having identical names in the file transmission programs 500 in FIG. 7, and they are all related like this. Therefore, it is assumed that the explanation given for the operations of the individual sections of the file transmission apparatus 510 in FIG. 8 also apply to the operations of the individual sections of the file transmission program 500 in FIG. 7.

The mail analyzer 512 of the file transmission apparatus 510 in FIG. 8 analyzes e-mail received by the mail receiver 511, and specifies, among the files in the user file 518, a file for which transmission request is received.

The mail analyzer 512 reads a designated file from the user file 518, and transmits the file to the file transmitter 513. Thereafter, the file transmitter 513 transmits the file received from the mail analyzer 512 to the web server 40 (see FIG. 1) on the Internet 10. In this embodiment, for the transmission of a file to a web server 40, the file transmitter 513 employs the FTP (File Transmission Protocol; a protocol used for transferring files between hosts on a TCP/IP based network. TCP/IP is a suite of TCP (Transmission Control Protocol) and IP (Internet Protocol)). HTTP may also be employed.

The analysis results obtained by the mail analyzer 512 are also transmitted to the server selector 515. Subsequently, in accordance with the analysis results, the server selector 515 selects one of plural web servers included in the web server information file 517, and notifies the file transmitter 513 the selected web server 40. The file transmitter 513 then transmits to the web server notified from the server selector 515 the file received from the mail analyzer 512.

The transmitted file recording unit 516 receives from the mail transmitter 513 information specifying a file that has been transmitted by the mail transmitter 513 to the web server 40, and records the received information. Thus, before transmitting a file, the file transmitter 513 directs an inquiry to the transmitted file recording unit 516 to determine whether the pertinent file has been already transmitted. If the file has already been transmitted, the re-transmission of the file is halted, to preclude an unnecessary file transmission.

Further, before a file transmission, the file transmitter 513 confirms the availability of free space at the destination web server 40. And when adequate disk space is available for the file that is to be transmitted, the file transmitter 513 transmits the file to the web server 40.

In addition, when transmitting a file, the file transmitter 513 first generates at the file destination a directory or a file name that can not be predicted, e.g., generates a directory or a file name at random, and then transmits the file to the URL that includes the thus generated directory or file name. Thereafter, the URL of the file transmission destination is reported to the mail notification unit 514.

Furthermore, the file transmitter 513 transmits to the web server 40 not only the file specified by the mail analyzer 512, but also a file in which is recorded a condition under which access of the file is permitted. This guidance is provided to prevent an unauthorized access by a third party.

The mail notification unit 514 transmits, to the terminal 20 that issued the e-mail requesting the transmission of a file, an e-mail indicating that the file has been transmitted that was requested using the e-mail received by the mail receiver 511. At this time, the mail notification unit 514 transmits to the terminal 20 an e-mail that includes the URL generated by the file transmitter 513 to prevent it from being predicted and that is used to access the file transmitted to the web server 40.

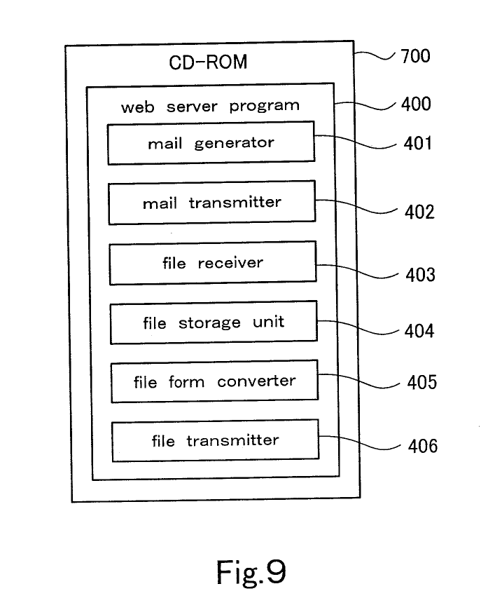

FIG. 9 is a schematic diagram showing the structure of a web server program that is stored on a web server program storage medium according to one embodiment of the present invention.

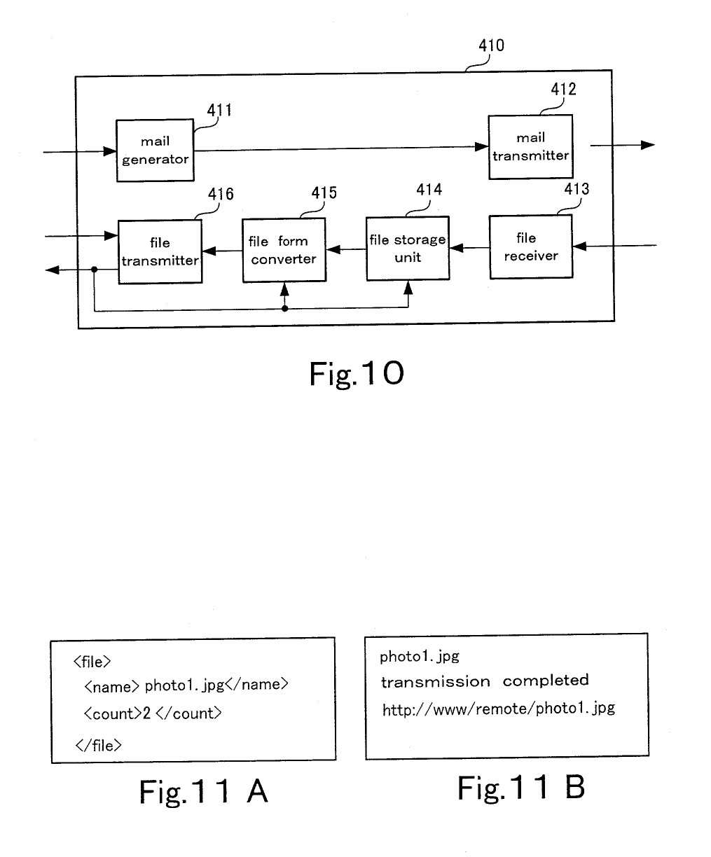

A web server program 400 in FIG. 9 is stored on a CD-ROM 700. The web server program 400 includes a mail generator 401, a mail transmitter 402, a file receiver 403, a file storage unit 404, a file form converter 405 and a file transmitter 406. The operations preformed by the individual sections will be described together with the description of the individual sections of a web server 410 in FIG. 10.

FIG. 10 is a functional block diagram showing a web server according to one embodiment of the present invention.

When the web server program 400 in FIG. 9 is installed in and executed by a computer that has the same arrangement as the computer 100 in FIGS. 5 and 6 and that is connected directly to the Internet 10, the web server 410 in FIG. 10 is constructed in the computer. The web server 410 corresponds to the file transfer function of the web server 40 in FIG. 1.

The web server 410 in FIG. 10 is a web server, on the Internet, that receives and stores a file and transmits the stored file to a transmission requesting source upon the reception of a request for the transmission of the file. The web server 410 includes a mail generator 411, a mail transmitter 412, a file receiver 413, a file storage unit 414, a file form converter 415 and a file transmitter 416, and these individual sections 411 to 416 correspond to the sections 401 to 406 having the same names in the web server program 400 in FIG. 9. The sections 411 to 416 are constructed using a combination of hardware and computer software, while the sections 401 to 406 of the web server program 400 in FIG. 9 are constructed by an application program. Therefore, it is assumed that the explanation given for the functions of the sections 411 to 416 of the web server 410 in FIG. 10 can also be applied for the explanation of the functions of the sections 401 to 406 of the web server program 400 in FIG. 9.

The mail generator 411 of the web server 410 in FIG. 10 receives an instruction from the terminal 20, which serves as a file transmission requesting source, and generates an e-mail for instructing the transmission of a file requested by the terminal 20.

For the generation of an e-mail, the mail generator 411 examines the terminal 20, accepts an instruction from the verified terminal 20, and generates an e-mail instructing the transmission of a file requested by the verified terminal 20.

Furthermore, the mail transmitter 412 transmits an e-mail created by the mail generator 411 to the home gateway 50 (see FIG. 1) in which a file requested by the terminal 20 is stored. Further, the file receiver 413 receives a file from the file transmission apparatus 50 that received the e-mail from the mail transmitter 412. At this time, the file receiver 413 receives, from the home gateway 50 (see FIG. 1), not only a file requested by the terminal 20, but also a file in which is recorded a condition under access of the file is recorded. These received files are temporarily stored in the file storage unit 414. Note that the file storage unit 404, which in FIG. 9 is a program part, does not store the file in itself, but accesses a hard disk (see the hard disk 120 in FIG. 6) and stores therein the file received by the file receiver 413.

The file transmitter 416 receives a file transmission request from the terminal 20, and transmits, to the terminal 20, the file stored in the file storage unit 414. During this process, the file transmitter 416 examines the terminal 20, and upon the reception of a transmission request from the verified terminal 20, transmits to the verified terminal 20 a file stored in the file storage unit 414. When the file transmitter 416 transmits the file stored in the file storage unit 414, the file is read from the file storage unit 414 to the file form converter 415, and the form of the file is changed by the file converter 415 into one that is appropriate for the type of the terminal 20 (e.g., change the number of characters in each line, or change from a color image to a monotone image). The file transmitter 416 transmits a file having an appropriate form obtained by the file form converter 415. Further, when the terminal 20 has issued a request for the transmission of a file in the file storage unit 414, and only when the request matches the condition under which accessing the file is permitted, the file transmitter 416 transmits the requested file to the terminal 20.

In this embodiment, the file form converter 415 is provided for the web server 410, and changes the file form into an appropriate form that matches the terminal 20. However, the mail generator 411 may create an e-mail that represents the type of the terminal 20, and the mail transmitter 412 may transmit the created e-mail to the home gateway 50, whereat the home gateway 50 may convert the file into a form appropriate for the terminal 20, and the obtained file may be transmitted to the web server 410 in FIG. 10. In this case, the file form converter 415 in FIG. 10 is not required.

The embodiment of the present invention will now be more specifically explained.

FIGS. 11A and 11B are diagrams showing example e-mails transmitted by and received by the terminal 20 in FIG. 1. In FIG. 11A is shown an example instruction e-mail transmitted by the terminal 20 to the home gateway 50, and in FIG. 11B is shown an example notification e-mail transmitted by the home gateway 50 to the terminal 20.

The instruction e-mail in FIG. 11A, transmitted by the terminal 20 to the home gateway 50 using XML (extensible Markup Language), one of the data description languages, conveys a request that the file “photo1.jpg” be transmitted, and a statement that the frequency whereat the file is referred to is two.

The notification e-mail in FIG. 11B, transmitted by the home gateway 50 to the terminal 20, is a text e-mail indicating that the transmission of the file “photo1.jpg” to the web server 40 has been completed, and that the URL at the transmission destination is “http://www/remote/photo1.jpg”.

The contents of the transmitted e-mail may be either merely text, or may be one that uses common standards such as SOAP (Simple Object Access Protocol; an XML based protocol for calling a service). The e-mail may also be designated by using the URL.

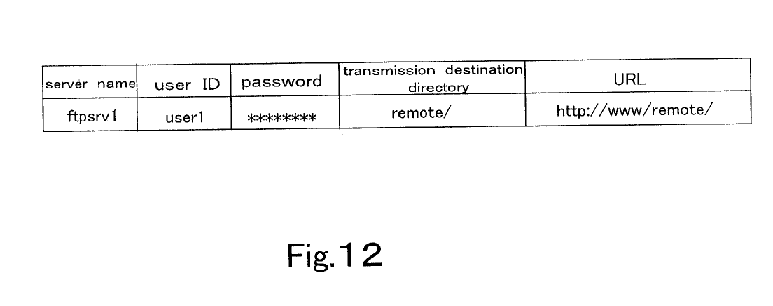

FIG. 12 is a diagram showing example web server information defined in the web server information file 517 in FIG. 8.

The server name is the name of an FTP server that runs a homepage, and a user ID and a password are used for logging in with the FTP server. A transfer destination directory is the directory for the FTP server that is the base used for transferring a file. The URL is for a homepage that corresponds to the base directory of the FTP server.

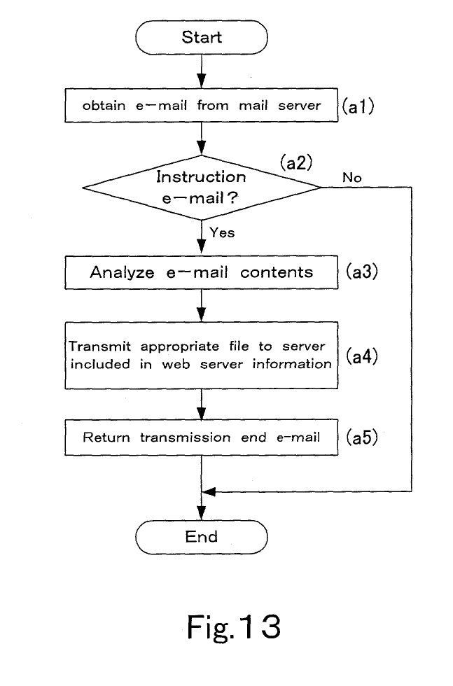

FIG. 13 is a flowchart showing a first example operation performed by a home gateway.

First, the home gateway uses POP to obtain an e-mail from the mail server (step a1). When the e-mail can not be obtained, or when the e-mail does not include a request for the transmission of a file, the processing is terminated (step a2). Whether the e-mail is an instruction e-mail is determined by examining the To Address or the Subject of the e-mail header, or the main body of the e-mail. When the e-mail is an instruction e-mail, the home gateway analyzes the contents of the e-mail (step a3). And when XML is employed for the contents of the instruction e-mail, the home gateway 50 confirms the contents of the e-mail using the XML parser by employing a DOM (Document Object Model; a rule for handling an XML document as an object). Based on the analysis results, the home gateway determines which file is to be transmitted, logs in with the FTP server for the web server information, moves to the transfer destination directory, transmits (puts) a file, and logs out (step a4). Finally, the home gateway transmits an e-mail to the source of the instruction e-mail to provide notification that the file transmission has been terminated.

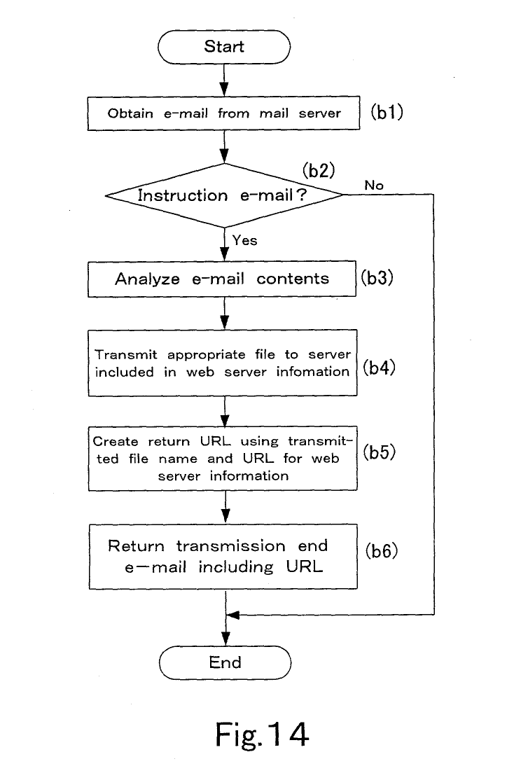

FIG. 14 is a flowchart showing a second example operation for the home gateway.

Since steps b1 to b4 are the same as steps a1 to a4 in FIG. 13, no further explanation for them will be given.

At step b5, the file name of a transmitted file and the URL for the web server information are employed to create a return URL that can be actually accessed. The file name of the transmitted file may include a directory. Finally, in response to the instruction e-mail, the home gateway transmits an e-mail, including the return URL, in order to provide notification that the transfer has been terminated (step b6).

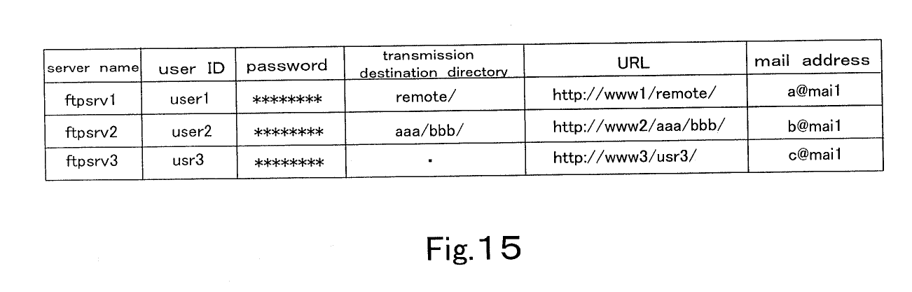

FIG. 15 is a diagram showing example web server information defined in a web server information file. In FIG. 15, a “mail address” column is added to columns that constitute the web server information in FIG. 12.

In this example, e-mail addresses of the terminals are recorded in the e-mail address column. When the transmission source address (From) in the e-mail header of the instruction e-mail is its e-mail address, the file is transmitted to the pertinent web server. In FIG. 15, the “.” in the “transmission source directory” column on the “ftpsrv3” row in the “server name” column represents the current directory.

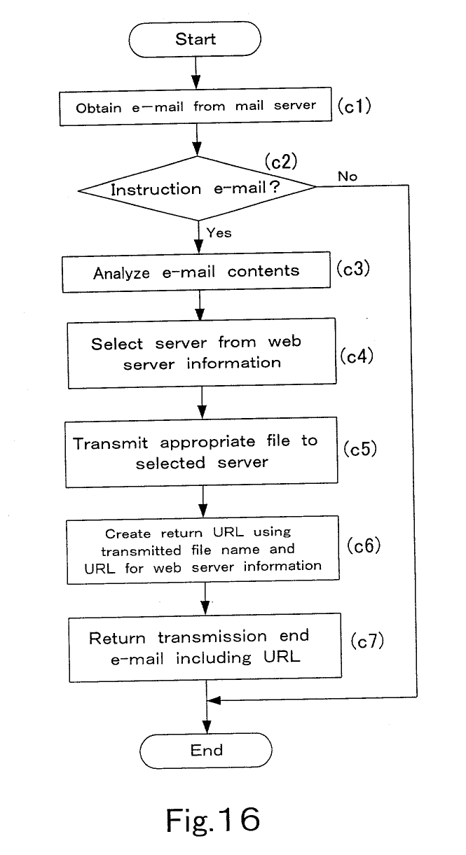

FIG. 16 is a flowchart showing a third example operation performed by the home gateway.

Since steps c1 to c3 of the flowchart in FIG. 16 correspond to steps b1 to b3 in the flowchart in FIG. 14 and steps c5 to c7 in FIG. 16 correspond to steps b4 to b6 in FIG. 14, the only difference in FIG. 16 is that step c4 has been added. At step c4 in FIG. 16, a web server to which a file is to be transmitted is selected by referring to the web server information. For this selection, in this embodiment, the From row for the e-mail header of the instruction e-mail is compared with the e-mail address of the web server information, and when the two correspond, the pertinent server is selected. A method for selecting a web server at random may also be employed. At step c5, the home gateway logs in with the thus selected FTP web server, shifts to the transfer destination directory, puts a file and logs out. At step c6, the home gateway employs the file name of the transmitted file and the URL of the selected web server to create a return URL that can actually be accessed. Finally, at step c7, in response to the instruction e-mail, the home gateway transmits an e-mail including the return URL in order to provide notification that the transfer has been completed.

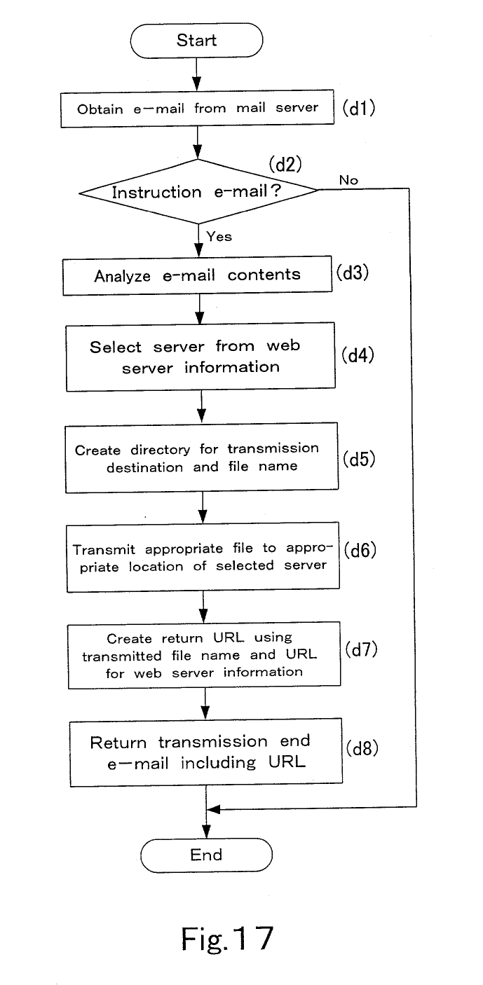

FIG. 17 is a flowchart showing a fourth example operation performed by the home gateway.

Steps d1 to d4 in the flowchart in FIG. 17 are the same as steps c1 to c4 in the flowchart in FIG. 16, step d5 in the flowchart in FIG. 17 is not included in FIG. 16, and steps d6 to d8 in the flowchart in FIG. 17 are the same as steps c5 to c7 in the flowchart in FIG. 16.

At step d5 in FIG. 17, the file name for the transmission destination, including the directory, is generated at random with no relation to the file name for the transmission source. A generation method using the date may be employed; however, in order to prevent its prediction, it is better the file name is generated completely at random. As a result, an unauthorized access by a third party can essentially be prevented.

At step d6 in FIG. 17, the home gateway employs the analysis results for the instruction e-mail to determine which file is to be transmitted, logs in the with the selected FTP web server, moves to the transmission directory, puts the file in a designated directory using a designated file name, and logs out. Further, at step d7, the home gateway employs the directory and the file name, which are generated at random for the transmission destination, and the URL of the selected server to create a return URL that can actually be accessed. Finally, at step d8, in response to the instruction e-mail, the home gateway transmits an e-mail including a return URL address in order to provide notification that the file transmission has been terminated.

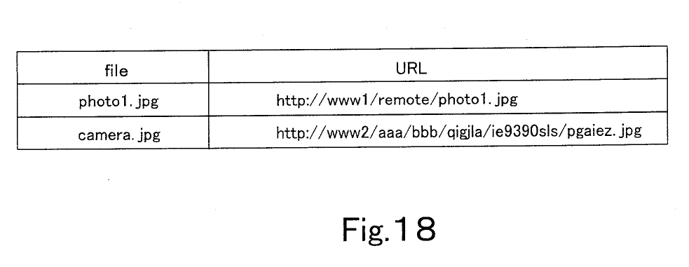

FIG. 18 is a diagram showing a list of transmitted files that are recorded by the transmitted file recording unit 516 in FIG. 8.

In FIG. 18, files that have been transmitted are recorded. In this example, only files are shown; however, directories may also be included. The URLs on the list are those to which files have been transmitted and that can actually be accessed.

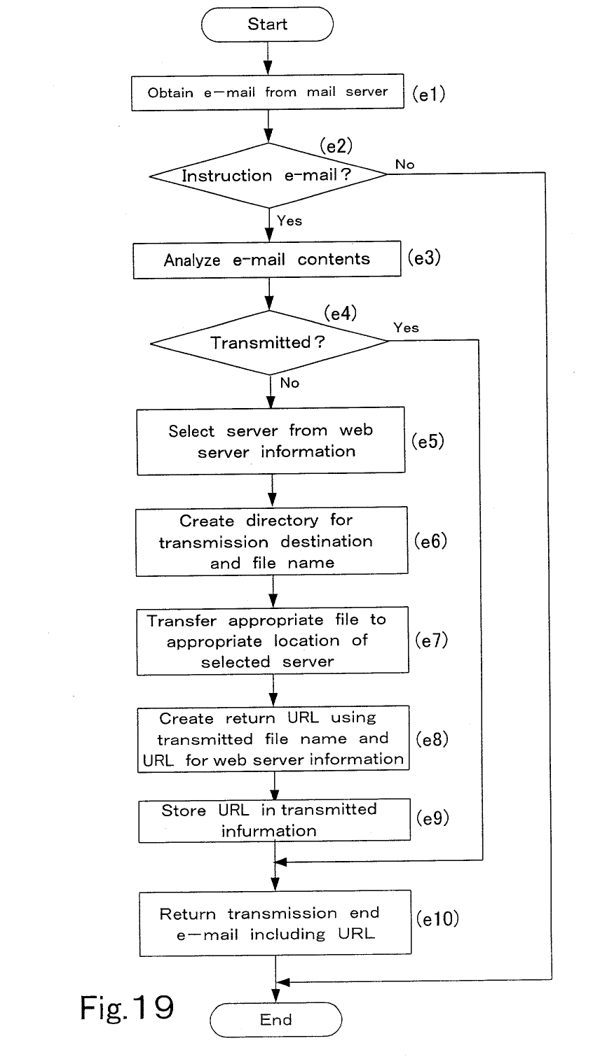

FIG. 19 is a flowchart showing a fifth example operation performed by the home gateway. In the flowchart in FIG. 19, steps e1 to e3, e5 to e8 and e10 correspond to steps d1 to d8 in the flowchart in FIG. 17, and steps e4 and e9 are those that are added to the flowchart in FIG. 17.

At step e4, a file that it is requested be transmitted is compared with information in FIG. 18 that has been transmitted. When the requested file is one that has already been transmitted, the URL is extracted from the transmitted information, and in response to the instruction e-mail, an e-mail is transmitted wherein the URL is included (step e10). When the requested file has not yet been transmitted, program control advances to step e5 and the processing is continued.

At step e9, the URL associated with the file that has currently been transmitted is stored in the transmitted information.

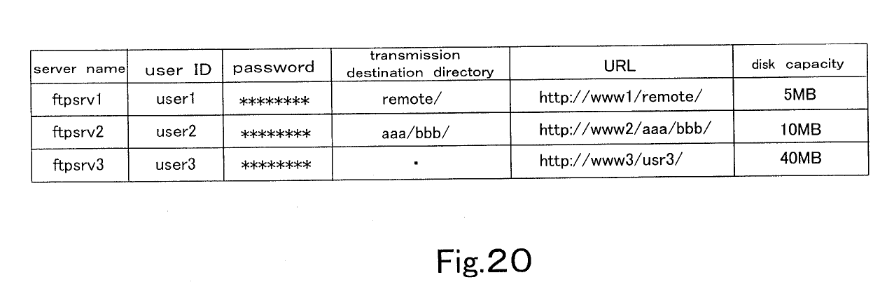

FIG. 20 is a diagram showing another web server information example. Multiple sets of web server information are recorded, and additional information concerning the available disk capacity of each web server is recorded.

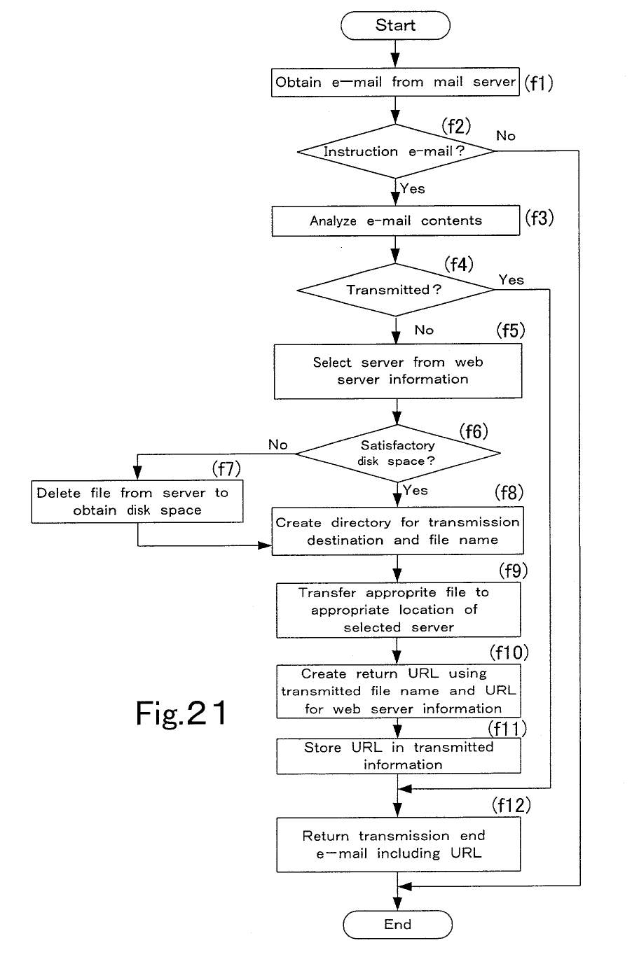

FIG. 21 is a flowchart showing a sixth example operation performed by the home gateway.

In the flowchart in FIG. 21, since steps f1 to f5 and f8 to f12, excluding steps f6 and f7, are the same as steps e1 to e10 in the flowchart in FIG. 19, no further explanation for them will be given.

At step f6, the available disk capacity (see FIG. 20) of the web server selected at step f5, the capacity of the disk currently used by the selected web server, and the size of a file to be transmitted to the web server are employed to determine whether the transmission of the file is enabled. When the free disk space at the selected web server is not satisfactory, program control advances to step f7 and a file stored by the web server is deleted in order to obtain an appropriate disk capacity.

The other processing is performed in the same manner as in the flowchart in FIG. 19.

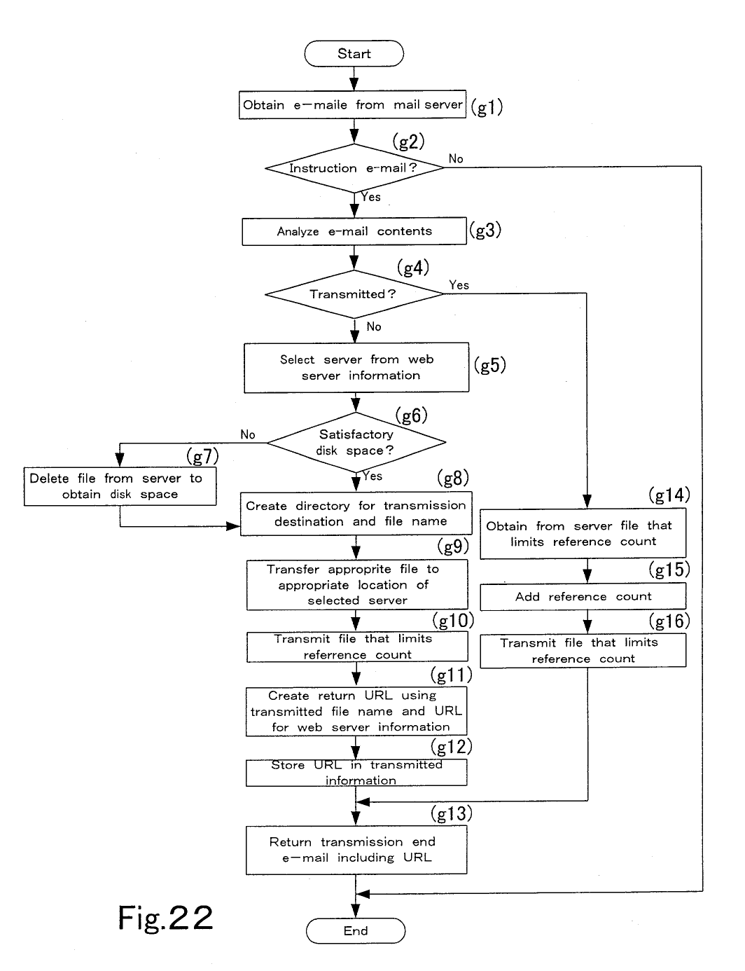

FIG. 22 is a flowchart showing a seventh example operation performed by the home gateway.

In the flowchart in FIG. 22, since steps g1 to g9 and g1 to g13 are the same as steps f1 to f12 in the flowchart in FIG. 21, only those steps that are different, e.g., step g10 and steps g14 to g16, will now be described.

At step g10, the home gateway transmits, to the web server, a reference count file that limits the number whereat a file transmitted to the web server at step g9 is actually referred to. At this time, for reference, the home gateway also transmits to the web server a CGI (Common Gateway Interface; one of the methods used for adding a function other than the ones defined for a web server by HTML, this interface is also used for the exchange of information by a web server and a program operated at the back end). The CGI is used to access the reference count file each time a file is actually referred to, to decrement the reference count, and to disable the actual reference to a file when the reference count reaches zero, at which time the file may be deleted from the web server. In this example, the reference count is employed to limit the actual file accesses; however, an effective period for referring to a file may be employed.

At step g4, the file for which transmission has currently been requested is compared with the information transmitted for the file (see FIG. 8). When the file that is currently requested has already been transmitted, program control advances to step g14 and a file that limits the reference count for the transmitted file is obtained from the web server. Then, the reference count designated by the current instruction e-mail is added to the reference count maintained in the file (step g15). The home gateway then transmits (puts) the resultant reference count file to the web server, and logs out without actually transmitting the file (step g6).

As a result, the transmission overlapping of the same file can be prevented.

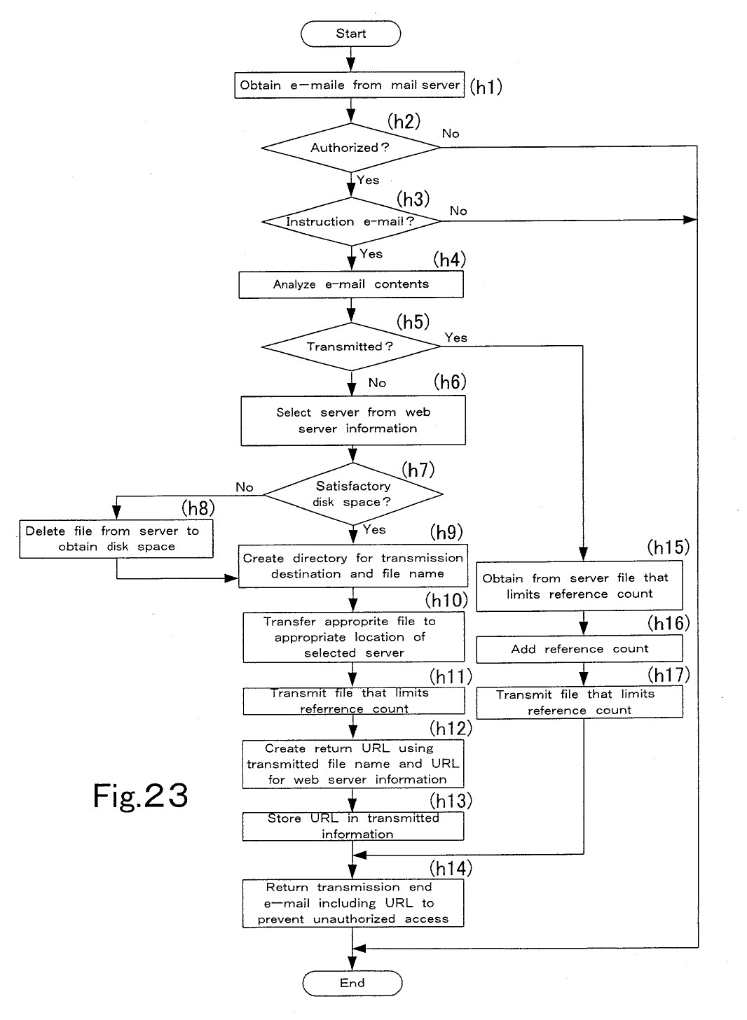

FIG. 23 is a flowchart showing an eighth example operation performed by the home gateway.

In the flowchart in FIG. 23, since steps h1 and h3 to h14, excluding step h2, are the same as steps g1 to g13 in the flowchart in FIG. 22, no further explanation for them will be given.

At step h2 in the flowchart in FIG. 23, an e-mail obtained from the mail server at step hi is examined to determine whether it is authorized. Only after it has been verified that the e-mail is authorized, the processing is performed. As a result, an unauthorized access by a third party can be prevented. For this prevention, a signature or encryption using PGP etc. is employed.

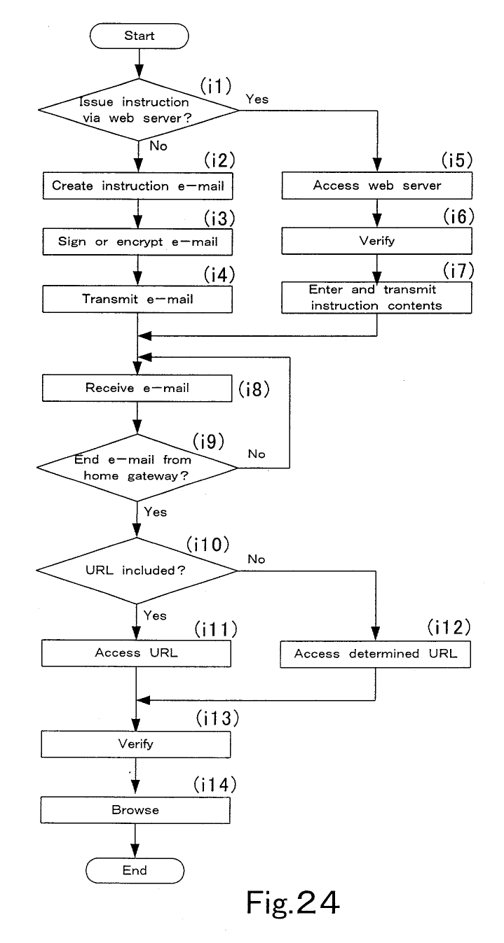

FIG. 24 is a flowchart showing the operation of a terminal.

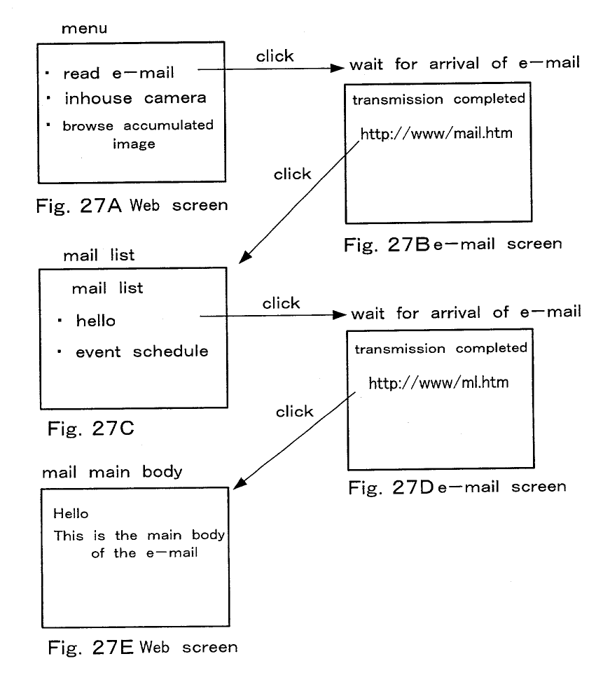

First, at step i1, the terminal determines whether it will create an instruction e-mail or will permit a web server to create an instruction e-mail. When the terminal creates an instruction e-mail, a format that is defined in advance to obtain the information that is to be remotely accessed by a user is used (step i2). Then, a signature is provided or encryption is performed to verify that the e-mail is correct (step i3). The process can be implemented by using PGP etc. Thereafter, the terminal transmits the e-mail to the home gateway (step i4). Since the succeeding processing is performed in the same manner as when the web server transmits an e-mail, e-mail transmission via the web server will be explained first. To issue an instruction e-mail through the web server, the web server that provides such a service is logged in (step i5). The log-in is performed by using an ID or a password, and this becomes the verification (step i6). When SSL (Secure Socket Layer; one of the security protocols used to prevent wiretapping during the exchange and alteration of data) is employed for the access, the leakage of a password can be prevented and security is further improved. When the e-mail address of the home gateway that accesses data and the type of information that the home gateway provides are registered in advance with the web server, after the log in, the information to be accessed only need be selected, so that the process up to the transmission of an instruction e-mail can be performed. Naturally, either all the data may be entered or only a part may be entered. Through the above processing, an e-mail is transmitted to the home gateway (step i7). The succeeding process is performed in the same manner as when the terminal creates an e-mail and when the web server transmits an e-mail. After the e-mail has been transmitted, the arrival of an e-mail indicating that the home gateway has terminated the processing is waited for (step i8). When the e-mail transmitted to the terminal is the end e-mail from the home gateway (step i9), a check is performed to determine whether the URL that is the data access destination is included in the e-mail (step i10). If the URL is included, the URL is accessed (step i11). If the URL is not included, a URL that is defined in advance is accessed (step i12). Depending on the terminal, a browser can be automatically activated by using a pointing device to click on the URL in the e-mail, and the page can be read. The page indicated by the URL is examined in order to prevent wiretapping (step i13). In this case, communication is encrypted using SSL to prevent the leaking of information. After the verification, the information can be browsed. When the list of information provided by the home gateway is known in advance, or when such information is recorded in the web server, only the accessing of the data need be instructed. However, when there is no such information, a list of the information is obtained by repeating the processing sequence, and information is selected from the list, so that the desirable data can be finally reached. This example will be described later while referring to FIG. 27.

The operation of the web server will now be explained.

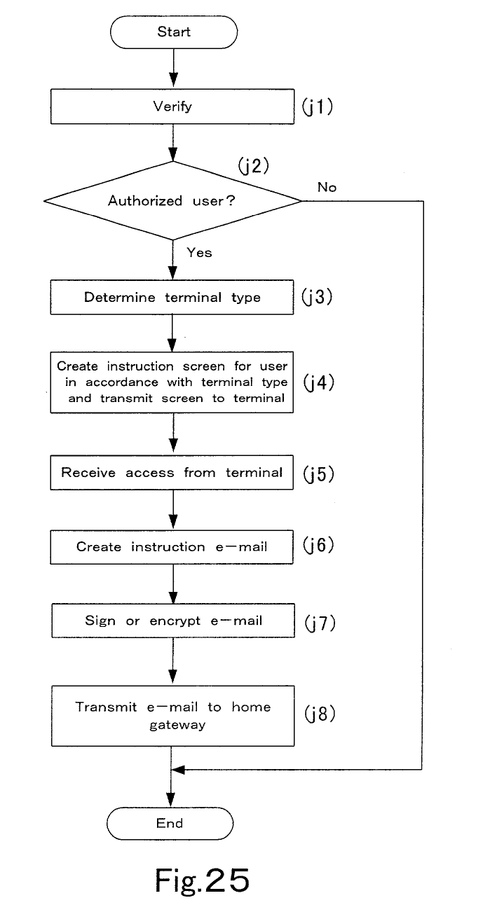

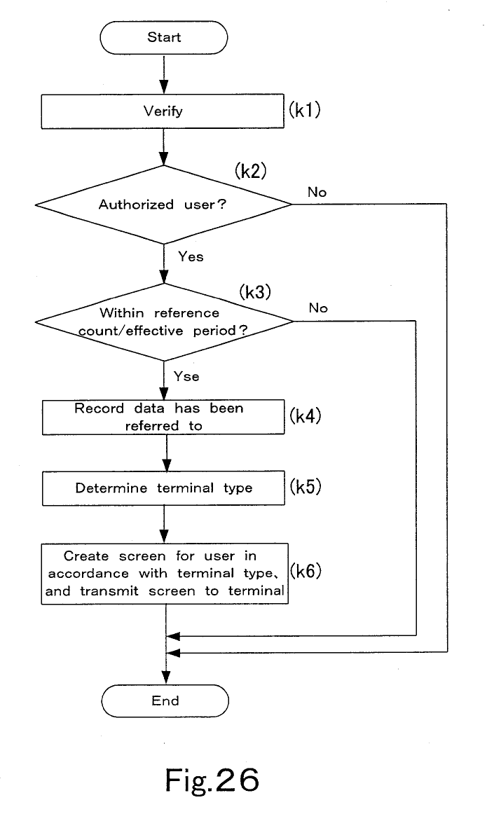

The web server has two roles: the transmission of an instruction e-mail and the accessing of information. Separate web servers may be employed for these individual roles, or the same web server may be employed to provide the two functions. The e-mail transmission process and the data access process will now be described while referring to FIGS. 25 and 26.

FIG. 25 is a flowchart showing the e-mail transmission processing performed by the web server.

Upon an access having been made by the terminal, the web server determines whether the access has been effected by an authorized user (step j1). This process may be performed at the log-in, or through verification procedures provided by the web server. Further, an access by the terminal of the web server may also be made using HTTP or HTTPS (Hypertext Transfer Protocol Security; the protocol obtained by adding the security provided by SSL to HTTP); HTTPS is preferable when password leakage must be avoided. When the verification process has ascertained that the user is authorized (step j2), the terminal type is examined (step j3). The terminal type is determined by employing, for example, HTTP_USER_AGENT, which is provided as an environment variable for the web server. Then, an instruction screen is created in accordance with the user and the terminal type, and is transmitted to the terminal (step j4). In this case, it is assumed that the user has registered information concerning the home gateway in advance. The information for the home gateway includes the e-mail address for the home gateway, which is a transmission destination, a key used to encrypt e-mail in order to prevent the forwarding of unauthorized e-mail to the home gateway, and a list of the information that can be transmitted by the home gateway. Upon an access being effected by the terminal (step j5), the instruction e-mail is created (step j6). The terminal and the web server may exchange data not merely one time, but repetitively, many times. In accordance with the registered contents held by the web server, information elements may be individually selected from the list, or all the information may be entered by the terminal. When, as a result of the exchange of data with the terminal, the creation of an instruction e-mail or the signing or encryption of the e-mail is required, a corresponding process is performed (step j7), and the e-mail is transmitted to the home gateway (step j8).

FIG. 26 is a flowchart showing the data access processing performed by the web server.

Upon an access being effected by the terminal, whether the access was made by an authorized user is determined (step k1). This process may be performed by using the log-in process or by the verification procedures provided by the web server, either HTTP or HTTPS may be employed for an access by the terminal. When as a result of the verification procedures it is ascertained that the user is authorized (step k2), a check is performed to determine whether an access limit has been imposed (step k3). A reference count or an effective period may be employed as an access limit. When a limited reference count has been imposed, each information referral event is recorded until the reference count limit is reached (step k4). This process can be carried out by a method employed by the web server, such as the CGI. The access of the terminal is directed to the CGI, and whether the access is enabled can be determined by referring to the file in which the reference count or the effective period is written. Since the file contents can also be rewritten, the current reference count can be updated. Then, the terminal type is determined (step k5), and in accordance with the screen size and the number of colors, an image conversion is performed as needed based on the user or the terminal type, and the results obtained by the conversion are transmitted to the terminal (step k6).

FIGS. 27A to 27E are diagrams showing examples presented on the display screen of the terminal.

On the terminal, first, the menu screen shown in FIG. 27A received from the web server is displayed.

When “read an e-mail” is clicked (selected) on the terminal screen, the web server creates an instruction e-mail instructing that e-mails to a user be referred to, and transmits the instruction e-mail to the home gateway. The home gateway then transmits an e-mail list to the web server, and thereafter, transmits the transmission end e-mail in FIG. 27B to the terminal. The terminal reads the received e-mail in FIG. 27B, and clicks on the URL for the e-mail. Then, the web server transmits the e-mail list shown in FIG. 27C. Assuming that “hello” mail is selected from the e-mail list, the web server creates an instruction e-mail instructing the transmission of the “hello” mail that it transmits to the home gateway. Upon the reception of the instruction e-mail, the home gateway transmits the “hello” mail to the web server, and also transmits the transmission end e-mail in FIG. 27D to the terminal. The terminal confirms the transmission end e-mail in FIG. 27D, and clicks on the URL for the e-mail. The web server then transmits the “hello” mail to the terminal where the main body of the “hello” mail is displayed on the terminal screen.

To simplify the foregoing explanation, an e-mail for character data has been employed. However, by employing the same processing, an image file can be obtained by the terminal.

What is claimed is:

1. A file transmission apparatus, which receives an e-mail and transmits a file as instructed by the e-mail, comprising:
a mail receiver receiving an e-mail;
a mail analyzer analyzing the e-mail received by the mail receiver and specifying a requested file for transmission; and
a file transmitter transmitting, to a web server on the Internet, the file specified by the mail analyzer.

2. A file transmission apparatus according to claim 1, further comprising:
a mail notification unit for transmitting, to an e-mail transmission source, an e-mail indicating that the file transmitter has transmitted to the web server a file requested by the e-mail received by the mail receiver.

3. A file transmission apparatus according to claim 2, wherein the mail notification unit transmits to the e-mail transmission source an e-mail that includes a URL used to access a file transmitted by the file transmitter to the web server.

4. A file transmission apparatus according to claim 1, further comprising:
a server selector selecting one of multiple web servers to which the file specified by the mail analyzer is to be transmitted,
wherein the file transmitter transmits the file specified by the mail analyzer to the web server that is selected by the server selector.

5. A file transmission apparatus according to claim 3, wherein, in order for a file specified by the mail analyzer to be transmitted to the web server, the file transmitter generates at a transmission destination a directory and/or a file name that can not be predicted, and transmits a file to a URL whereat the directory and/or the file name has been generated.

6. A file transmission apparatus according to claim 1, further comprising:
a transmitted file recording unit recording information for specifying a file that is transmitted by the file transmitter,
wherein the file transmitter refers to information recorded in the transmitted file recording unit to avoid the re-transmission of a file that has already been transmitted.

7. A file transmission apparatus according to claim 1, wherein the file transmitter confirms the availability of free disk space at the web server, and obtains the free disk space required for a file before the file is transmitted to the web server.

8. A file transmission apparatus according to claim 1, wherein the file transmitter transmits, to the web server, together with the file specified by the mail analyzer, a file in which a condition is recorded for permitting a file access.

9. A file transmission apparatus according to claim 1, wherein the mail analyzer examines the transmission sources of e-mails that are received by the mail receiver, and analyzes an e-mail transmitted by a verified transmission source and specifies a requested file to be transmitted.

10. A web server on the Internet, one which stores a received file and transmits the file to a transmission requesting source upon the reception of a transmission request for the file, comprising:
a mail generator, upon receiving an instruction from a terminal that is operated as a file transmission requesting resource, creating an e-mail that instructs the transmission of a file requested by the terminal;
a mail transmitter transmitting the e-mail, created by the mail generator, to a file transmission apparatus whereat the file requested by the terminal is stored and whereat the e-mail is received and the file is transmitted as instructed by the e-mail;
a file receiver receiving the file from the file transmission apparatus that received the e-mail from the mail transmitter;
a file storage unit storing the file received by the file receiver; and
a file transmitter, upon receiving a request from the terminal for the transmission of the file stored in the file storage unit, transmitting the file to the terminal.

11. A web server according to claim 10, wherein the mail generator correctly examines the terminal, receives an instruction from the terminal that has been verified, and creates an e-mail instructing the transmission of a file requested by the terminal.

12. A web server according to claim 10, wherein the mail generator creates an e-mail including information representing a terminal type.

13. A web server on the Internet, one which receives and stores a file and transmits the file to a transmission requesting source upon the reception of a transmission request for the file, comprising:
a file receiver receiving a file;
a file storage unit storing the file received by the file receiver; and
a file transmitter, upon receiving a request for the transmission of the file stored in the file storage unit, transmits the file to a transmission requesting source,
wherein the file transmitter correctly examines the transmission requesting source, and upon receiving a transmission request from the transmission requesting source that has been verified, transmits the file stored in the storage unit to the transmission requesting source.

14. A web server on the Internet, one which receives and stores a file and upon the reception of a transmission request for the stored file transmits the file to a transmission requesting source, comprising:
a file receiver receiving a file;
a file storage unit storing the file received by the file receiver; and
a file transmitter, upon receiving a transmission request for the file stored in the storage unit, transmitting the file to the transmission request source,
wherein the file receiver receives the file and also receives a file in which is recorded the conditions under which access to the file is permitted, and
wherein the file transmitter transmits the file to the transmission requesting source only when the request received for the transmission of the file stored in the file storage unit matches the conditions under which access to the file is permitted.

15. A web server on the Internet, one which receives and stores a file and upon the reception of a transmission request for the file that is stored transmits the file to a transmission requesting source, comprising:
a file receiver receiving a file;
a file storage unit storing the file received by the file receiver;
a file transmitter, upon receiving a transmission request for the file stored in the file storage unit, transmitting the file to the transmission source;
a file form converter, upon receiving the transmission request for the file stored in the file storage unit, changing the file into a form appropriate for the type of transmission requesting source,
wherein the file transmitter transmits, to the transmission requesting source, the file for which the form has been changed by the file form converter.

16. A file transmission system comprising:
a file transmission apparatus receiving an e-mail and transmitting a file as instructed by the e-mail;
a web server, on the Internet, storing the file received from the file transmission apparatus and, upon receiving a transmission request for the stored file, transmitting the file to a transmission requesting source; and
a terminal communicating with the file transmission apparatus and the web server,
wherein the terminal issues an e-mail to the file transmission apparatus directly or via the web server to request the transmission of a file,
wherein the file transmission apparatus transmits the requested file to the web server,
wherein the terminal requests the web server to transmit the file that has been received from the file transmission apparatus, and
wherein the web server transmits the file to the terminal upon receiving a request from the terminal for the transmission of the file.

17. A file transmission system according to claim 16, wherein the file transmission apparatus transmits, to the web server, a file requested using an e-mail, and also transmits to the terminal an e-mail indicating that the file has been transmitted.

18. A file transmission program storage medium storing a file transmission program that is executed by a computer and that permits the computer to serve as a file transmission apparatus receiving an e-mail and transmitting a file as instructed by the e-mail,
wherein the computer comprises:
a mail receiver receiving an e-mail;
a mail analyzer analyzing the e-mail received by the mail receiver and specifying a file for which transmission has been requested; and
a file transmitter transmitting to a web server on the Internet the file specified by the mail analyzer.

19. A file transmission program storage medium according to claim 18, wherein the file transmission program permits the computer to serve as a file transmission apparatus comprising:
a mail notification unit transmitting, to an e-mail transmission source, an e-mail indicating that the file transmitter has transmitted to the web server a file requested by the e-mail received by the mail receiver.

20. A file transmission program storage medium according to claim 19, wherein, according to the file transmission program, the mail notification unit transmits to the e-mail transmission source an e-mail that includes a URL used to access a file transmitted by the file transmitter to the web server.

21. A file transmission program storage medium according to claim 18, wherein the file transmission program permits the computer to serve as a file transmission apparatus, and the computer further comprising:
a server selector selecting one of multiple web servers to which the file specified by the mail analyzer is to be transmitted, and
wherein the file transmitter transmits the file specified by the mail analyzer to the web server that is selected by the server selector.

22. A file transmission program storage medium according to claim 20, wherein, according to the file transmission program, in order for a file specified by the mail analyzer to be transmitted to the web server, the file transmitter generates at a transmission destination a directory and/or a file name that can not be predicted, and transmits a file to a URL whereat the directory and/or the file name has been generated.

23. A file transmission program storage medium according to claim 18, wherein the file transmission program permits the computer to serve as a file transmission apparatus, and the computer further comprising:
a transmitted file recording unit recording information for specifying a file that is transmitted by the file transmitter; and wherein the file transmitter refers to information recorded in the transmitted file recording unit to avoid the re-transmission of a file that has already been transmitted.

24. A file transmission program storage medium according to claim 18, wherein, according to the file transmission program, the file transmitter confirms the availability of free disk space at the web server, and obtains the free disk space required for a file before the file is transmitted to the web server.

25. A file transmission program storage medium according to claim 18, wherein, according to the file transmission program, the file transmitter transmits, to the web server, together with the file specified by the mail analyzer, a file in which a condition is recorded for permitting a file access.

26. A file transmission program storage medium according to claim 18, wherein, according to the file transmission program, the mail analyzer examines the transmission sources of e-mails that are received by the mail receiver, and analyzes an e-mail transmitted by a verified transmission source and specifies the requested file to be transmitted.

27. A web server program storage medium storing a web server program that is executed by a computer and that permits the computer to serve as a web server receiving and storing a file and transmitting the stored file to a transmission requesting source upon the reception of a transmission request,
wherein the computer comprises:
a mail generator receiving an instruction from a terminal that serves as a file transmission requesting source, and creating as instructed an e-mail to transmit the file requested by the terminal;
a mail transmitter transmitting the e-mail created by the mail generator to a file transmission apparatus receiving an e-mail and transmitting a file as instructed by the e-mail, whereat the file requested by the terminal is stored;
a file receiver receiving a file from the file transmission apparatus that has received the e-mail from the mail transmitter;
a file storage unit storing the file received by the file receiver; and
a file transmitter, upon receiving a request from the terminal for the transmission of a file stored in the file storage unit, transmitting the file to the terminal.

28. A web server program storage medium according to claim 27, wherein, according to the web server program, the mail generator correctly examines the terminal, receives an instruction from the terminal that has been verified, and creates an e-mail instructing the transmission of a file requested by the terminal.

29. A web server program storage medium according to claim 27, wherein, according to the web server program, the mail generator creates an e-mail including information representing a terminal type.

30. A web server program storage medium storing a web server program that is executed by a computer and that permits the computer to serve as a web server receiving and storing a file and transmitting the stored file to a transmission requesting source upon the reception of a transmission request,
wherein the computer comprises:
a file receiver receiving a file;
a file storage unit storing the file received by the file receiver; and
a file transmitter, upon receiving a transmission request for the file stored in the file storage unit, transmitting the file to a transmission requesting source,
wherein the file transmitter examines the transmission requesting source, and upon receiving a transmission request from the transmission requesting source that has been verified, transmits the file stored in the file storage unit to the transmission requesting source.

31. A web server program storage medium storing a web server program that is executed by a computer and that permits the computer to serve as a web server receiving and storing a file and transmitting the stored file to a transmission requesting source upon the reception of a transmission request,
wherein the computer comprises:
a file receiver receiving a file;
a file storage unit storing the file received by the file receiver; and
a file transmitter, upon receiving a transmission request for the file stored in the file storage unit, transmitting the file to a transmission requesting source,
wherein the file receiver receives a file, and also receives a file in which is recorded a condition under which access of the file is permitted, and
wherein the file transmitter transmits the file to the transmission requesting source only when a request received for the transmission of the file stored in the file storage unit matches the condition under which access of the file is permitted.

32. A web server program storage medium storing a web server program that is executed by a computer and that permits the computer to serve as a web server receiving and storing a file and transmitting the stored file to a transmission requesting source upon the reception of a transmission request,
wherein the computer comprises:
a file receiver receiving a file;
a file storage unit storing the file received by the file receiver;
a file transmitter, upon receiving a transmission request for the file stored in the file storage unit, transmitting the file to a transmission requesting source; and
a file form converter, upon receiving a transmission request for the file stored in the file storage unit, changing the file into a form matching the type of the transmission requesting source,
wherein the file transmitter transmits, to the transmission requesting source, the file for which the form has been changed by the file form converter.
